(19) United States
(12) Patent Application Publication
(10) Pub. No.: US 2025/0361678 A1
(43) Pub. Date: Nov. 27, 2025

(54) METHOD FOR MANUFACTURING A BARRIER SUBSTRATE, AND A BARRIER SUBSTRATE

(71) Applicant: Stora Enso OYJ, Helsinki (FI)

(72) Inventors: Tommi Nordström, Turku (FI); Kaj Backfolk, Lappeenranta (FI); Isto Heiskanen, Imatra (FI)

(73) Assignee: Stora Enso OYJ, Helsinki (FI)

(21) Appl. No.: 18/851,729

(22) PCT Filed: Feb. 20, 2023
(86) PCT No.: PCT/IB2023/051524

§ 371 Date: Sep. 27, 2024

(30) Foreign Application Priority Data
Mar. 28, 2022 (SE) 2230094-1

(51) Int. Cl. D21H 11/02; D21H 23/56; D21H 25/06

(52) U.S. Cl. CPC D21H 11/02; D21H 23/56; D21H 25/06

(57) ABSTRACT

The present invention relates to a process for manufacturing a barrier substrate, comprising the steps of: —providing a web comprising at least one first layer, which first layer comprises at least 30 weight-% highly refined cellulose fibers having a Schopper Riegler value of 60-95 SR # and/or at least 30 weight-% microfibrillated cellulose (MFC), as calculated on the total dry weight of said first layer, which web has a first side and a second side and which web exhibits an air resistance (Gurley) of at least 1000 s/100 ml, preferably at least 2000 s/100 ml, as measured according to ISO 5636-5, —providing a heated roll or a heated belt, —applying at least one first composition comprising a polymer dispersed or dissolved in an aqueous medium on the first side of the web while the web is in contact with the heated roll or belt, in a first coating step, thereby providing the web with a first barrier layer forming a barrier coated web, —optionally drying said web provided with the first barrier layer in a drying step. 20 The invention relates also to a barrier substrate, a barrier substrate laminate with a polymer layer and a packaging material comprising the barrier substrate.

### TECHNICAL FIELD

The present disclosure relates to a method for manufacturing a barrier substrate, e.g. for a paper or paperboard based packaging material, which barrier substrate comprises a layer comprising a high amount of highly refined cellulose or microfibrillated cellulose (MFC) and an aqueous based barrier layer. In addition, the present disclosure relates to a barrier substrate, a barrier substrate laminate, and a paperboard-based packaging material comprising the barrier substrate or the barrier substrate laminate.

### BACKGROUND

Barrier substrates comprising cellulose fibers, including films or papers comprising high amounts of highly refined cellulose, nanocellulose or microfibrillated cellulose (MFC), are known in the art. Depending on how they are produced the cellulose-based barrier substrates may have particularly advantageous strength and/or barrier properties, whilst being biodegradable and recyclable or repulpable. Such barrier substrates may be used in, for example, the manufacture of packaging materials and may be laminated or otherwise provided on paper or paperboard packaging materials. Use of cellulose-based barrier substrates in packaging materials facilitate re-pulping and recycling of the used packaging materials.

However, the gas (oxygen, aroma) and oil/grease barrier properties of cellulose-based barrier substrates may be excellent, but sensitive to moisture or (higher) relative humidity. In particular, the gas barrier properties of such barrier substrates tend to deteriorate at high temperatures and high humidity, such as when exposed to tropical conditions or conditions allowing condensation.

Many approaches for improving the barrier properties towards oxygen, air, water vapour and aromas at high relative humidity have been investigated and described. For example, various chemical solutions, such as coatings, lamination and surface-treatments, have been tested for improving the gas barrier properties of cellulose-based barrier substrates at high relative humidity or to provide the barrier substrates with improved barrier against water vapor. In order to retain the repulpability of the barrier substrate, aqueous-based barrier coatings may be preferred. Such aqueous-based barrier coatings may be formed by means of a liquid film coating process, whereby an aqueous solution or dispersion comprising a barrier chemical is spread out on the substrate and thereafter dried.

However, difficulties may arise when providing aqueous-based coatings on thin cellulose-based substrates comprising highly refined fibers or MFC. When such water-based solutions or dispersions are applied onto a thin cellulose-based substrate comprising highly refined fibers or MFC, the web may break or problems with dimensional stability (expansion when wetted and/or (uneven) shrinkage when dried) may occur. This is due to wetting and water sorption and penetration into the hydrophilic substrate, causing the web with highly refined fibers or fibrils to expand or swell and affecting the hydrogen bonds between the fibrils, fibers, and the additives. Thus, web tension control may be difficult in the machine direction. Also, the web handling in the cross machine direction may be difficult.

One solution is to increase the solids of the applied solutions or dispersions in order to reduce the wetting of the web, although this often leads to higher coat weight and higher viscosity of the solution. High viscosity, on the other hand, generates higher stresses on the substrates and often higher coat weights.

Another solution is to increase the basis weight of the cellulose-based web or substrate, since a higher basis weight implies a stronger material due to more fiber-fiber bonds. However, higher grammage means higher cost, a need of higher drying capacity, slower drainage (web forming) and larger reel diameter (less meter per reel when converting). Higher grammage could lead to rougher surface and/or formation of pinholes.

A further solution to reduce water sensitivity of the web is to enhance the wet strength and/or hydrophobicity of the web by adding wet strength agents and/or hydrophobizing agents to the furnish. Addition of hydrophobizing agents, might on the other hand, influence the barrier properties and might cause problems when further converting, especially if converting at high temperatures. In addition, both wet strength and hydrophobizing agents makes it more difficult to disintegrate the substrate at the re-pulping and recycling.

Thus, there is still room for improvements of methods for producing thin cellulose-based barrier substrates coated with aqueous-based barrier coatings.

### DESCRIPTION OF THE INVENTION

It is an object of the present invention to provide an improved method for manufacturing a barrier substrate, e.g. for a paperboard based packaging material, which barrier substrate has good barrier properties and which method eliminates or alleviates at least some of the disadvantages of the prior art methods.

It is a further object of the present invention to provide a method for manufacturing a thin cellulose-based barrier substrate that exhibits high barrier properties and high strength properties and that is repulpable. The above-mentioned objects, as well as other objects as will be realized by the skilled person in the light of the present disclosure, are achieved by the various aspects of the present disclosure.

According to a first aspect illustrated herein, there is provided a method for manufacturing a barrier substrate, comprising the steps of:
providing a web comprising at least one first layer, which first layer comprises at least 30 weight-% highly refined cellulose fibers having a Schopper Riegler value of 60-95 SR° and/or at least 30 weight-% microfibrillated cellulose (MFC), as calculated on the total dry weight of said first layer, which web has a first side and a second side and which web exhibits an air resistance (Gurley-Hill) of at least 1000 s/100 ml, preferably at least 2000 s/100 ml, as measured according to ISO 5636-5,
providing a heated roll or a heated belt,
applying, in a first coating step, at least one first composition comprising a polymer dispersed or dissolved in an aqueous medium on the first side of the web while the second side of the web is in contact with the heated roll or belt so that water applied with the aqueous composition on the web is evaporated thereby providing the web with a first barrier layer forming a barrier coated web, and
optionally drying said web provided with the first barrier layer in a drying step.

According to the invention, the second side of the web is in contact with the heated roll or heated belt at a defined area of the web, and the first composition is applied on the first side of the web at a point which is directly opposite to the area of the web which is in contact with the heated roll or heated belt.

It has surprisingly been found that when a thin web comprising highly refined cellulose fibers and/or MFC is coated with an aqueous-based composition while the web is in contact with a heated roll or belt, less water is penetrated into and/or is absorbed by the web. In this way, problems with fiber/fibril swelling causing loss of tensile strength and decreased dimension stability are avoided.

The term “barrier substrate” as used herein generally refers to a thin continuous sheet formed material with low permeability for gases and/or liquids. Depending on the composition of the pulp suspension, the substrate can be defined as a barrier film or as a thin barrier paper. Preferably, the barrier layer provides a barrier against at least one of gas, such as oxygen, oil, grease, liquid and water vapor.

As mentioned above, the method of the first aspect of the present disclosure comprises a step of providing a web comprising at least one first layer comprising at least 30 weight-%, or preferably 50 weight % or at least 70 weight %, such as between 30-99 weight %, or 50-99 weight %, or 70-99 weight %, highly refined cellulose pulp and/or at least 30 weight-% microfibrillated cellulose (MFC), or preferably at least 50 weight % or at least 70 weight %, such as between 30-99 weight %, or 50-99 weight or 70-99 weight % of MFC based on total dry weight of said layer.

The highly refined cellulose fibers of the web used in the method of the first aspect has a Schopper Riegler value (SR°) of 60-95 SR°, preferably in the range of 70-92 SR°, more preferably in the range of 75-92 SR°, most preferably in the range of 75-90 SR° or 80-90 SR° or 85-90 SR°, as determined by standard ISO 5267-1. The SR value is determined for a pulp of the fibers without additional chemicals, thus the fibers have not consolidated into a substrate or started e.g. hornification.

In some embodiments, the highly refined cellulose fibers of the web used in the method of the first aspect has a water retention (WRV) value of ≥200%, more preferably ≥300%. In addition, the WRV value is preferably ≤400%, more preferably ≤380% or ≤370% or ≤350%. In some embodiments, the highly refined cellulose fibers used in the method of the first aspect has a WRV value of 250-400%, or 250-380%, or 250-350%, or 300-350%. The WRV value may be determined by standard ISO 23714 with the use of a 200 mesh wire.

The highly refined cellulose fibers of the web used in the method of the first aspect can be produced in many different ways using methods known in the art to achieve the desired Schopper-Riegler value and the desired WRV value

Microfibrillated cellulose (MFC) shall in the context of this patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In some embodiments, the first layer of the web comprises one or more further cellulose pulp fractions in addition to the highly refined cellulose fibers and/or the MFC, which one or more further cellulose pulp fractions have been refined to different refining degrees than the highly refined cellulose and/or the MFC. In some embodiments, the first layer of the web comprises a fraction of normal fibers. The first layer of the web may comprise, for example, 1-30 weight-%, more preferably 2-30 weight-%, most preferably 5-30 weight-% of normal fibers.

By normal fibers is meant normal pulp fibers of a conventional length and fibrillation for papermaking. Normal fibers may include mechanical pulp, thermochemical pulp, chemical pulp such as sulphate (kraft) or sulphite pulp, dissolving pulp, recycled fiber, organosolv pulp or chemi-thermomechanical pulp (CTMP), or combinations thereof. The pulp may be bleached or unbleached. The normal fibers can be vegetable fibers, such as wood derived (e.g. hardwood or softwood) or agricultural sources including straw, bamboo, etc. The normal fibers may have a beating degree, i.e. Schopper-Riegler value, in the range of 15 to 50 SR° or more preferably in the range of 18 to 40 SR°. The normal fibers may preferably be chemical pulp, such as kraft pulp. The normal fibers may have an average length in the suspension of 1 mm to 5 mm, more preferably in the range of 2 to 4 mm.

The first layer of the web may, in addition to fibers and/or MFC, comprise any conventional paper making additives or chemicals such as fillers, pigments, wet strength chemicals, retention chemicals, cross-linkers, softeners or plasticizers, adhesion primers, wetting agents, biocides, optical dyes, colorants, fluorescent whitening agents, de-foaming chemicals, hydrophobizing chemicals such as AKD, ASA, waxes, resins, bentonite, stearate, wet end starch, silica, precipitated calcium carbonate, cationic polysaccharide, etc. In embodiments, the web comprises less than 10 wt %, preferably less than 8 wt % or less than 5 wt % of fillers, as calculated on the total dry weight of the web.

In embodiments, the web consists of the first layer.

In other embodiments, the web comprises the first layer and a second layer. In such embodiments, the second layer may, similar to the first layer, comprise at least 30 weight-%, or preferably 50 weight % or at least 70 wight %, such as between 30-99 weight %, or 50-99 weight %, or 70-99 weight %, highly refined cellulose pulp and/or at least 30 weight-% microfibrillated cellulose (MFC), or preferably at least 50 weight % or at least 70 weight %, such as between 30-99 weight %, or 50-99 weigh5 or 70-99 weight % of MFC based on total dry weight of said second layer. In embodiments, the second layer may have the same composition as the first layer. In alternative embodiments, the second layer may comprise cellulose fibers, such as normal fibers as defined above, in an amount of between 50-99 weight %, or 60-99 weight % or 70-99 weight %, but less than 30 weight % or less than 20 weight %, or less than 10 weigh %, or less than 5 weight % of highly refined fibers or MFC, as calculated on the dry weight of said second layer.

The web used in the method of the first aspect may be formed by wet laid techniques, such as similar to a papermaking process, or by casting techniques. In wet laid techniques, the web may be formed by the application of an aqueous suspension comprising the highly refined fibers or MFC on a porous wire whereafter it is dewater and/or dried in a drying section to form the web. In casting technologies, the web may be formed by application of an aqueous suspension comprising the highly refined fibers or MFC onto a non-porous cast substrate, such as a polymeric or metal substrate. The thereby formed web may thereafter be dewatered, e.g. by pressing, and/or dried by evaporation.

The above-mentioned problems with web-weakening and decreased dimensions stability are specifically significant in the production of thin, low grammage barrier films or papers.

In embodiments, the web, before being applied with the first composition, has a grammage of less than 100 gsm, such as between 10-100 gsm, or 10-70 gsm, or 50-100 gsm. In preferred embodiments, the web has a grammage of less than 65 gsm, preferably less than 40 gsm, such as a grammage of between 10-65 gsm, or 20-40 gsm. In embodiments, the web, before being applied with the first composition, has a thickness of less than 50 μm, preferably less than 45 μm, most preferably less than 40 μm or less than 35 μm, such as a thickness of between 10-50 μm, or 10-45 μm or 10-35 μm.

The web used in the method of the first aspect may preferably have a dry content of above 70% or above 80% or above 90% by weight, before being applied with the at least one first composition.

In some embodiments, the web used in the method of the first aspect and before being applied with the first composition has a density of above 600 kg/m³ or above 750 kg/m³, or above 800, or above 850 kg/m³ such as between 600-1200 kg/m³, preferably 650-1200 kg/m³, most preferably 750-1200 kg/m³. The higher densities can be achieved by e.g., calendaring of the web or by using fillers.

As mentioned, the web used in the method of the first aspect has an air resistance (Gurley) of at least 1000 s/100 ml, preferably at least 2000 s/100 ml. In embodiments, the air resistance (Gurley) is at least 25000 s/100 ml, or at least 30000 s/100 ml. The air resistance may as used herein may also be referred to as the Gurley Hill value and is measured using the standard method ISO 5636-5, with a max value of 42 300 s/100 ml.

In embodiments, the method of the invention enables the use of a web that have a quite high content of pinholes, but still makes it possible to produce a barrier substrate with high barrier properties.

The method of the invention enables the use of less hydrophobizing agents and still avoid the above-mentioned problems caused by water applied with the aqueous-based barrier coating. The use of less hydrophobizing agents improves the recyclability of the substrate. Thus, the invention enables the use of a web with a quite high water absorption value that otherwise would be difficult to coat with aqueous-based coatings. In embodiments, the web, before being applied with the first composition, exhibits a water absorption value of above 15 g/m², preferably of above 25 g/m² as measured on the first side using COBB₆₀ in accordance with ISO 535:2014.

Moreover, the method of the invention enables the use of no or a low amount of wet strength agents and/or no or a low amount of internal sizing agents. A high amount of wet strength agents or internal sizing agents may reduce repulpability and may affect the barrier properties negatively. In embodiments, the web has a wet strength of below 0.7 kN/m, or preferably of below 0.6 kN/m or even below 0.5 kN/m, such as between 0.05-0.7 kN/m, or 0.1-0.6 kN/m or 0.4-0.6 kN/m as measured according to ISO 3781. In embodiments, the first layer of the web comprises internal sizing agents in an amount of less than 2 kg/ton, preferably in an amount of 0-1.5 kg/ton, as calculated on the dry weight of said first layer. In one embodiment, the substrate comprises no internal sizing agents. It has been found that barrier films or papers comprising no, or low amount of sizing agents are more easily repulped. However, a substrate comprising a low amount of internal sizing agents gives rise to a substrate that is more sensitive to wetting when applied with an aqueous-based solution or dispersion using the methods disclosed in the prior art. The current invention enables the production of a barrier film or paper that is easily repulped (partly due to low amount of internal sizing agents), but which still exhibits high tensile strength and dimensional stability.

Internal sizing agents refer to agents added to the substrate for making it more hydrophobics. Internal sizing agents may be selected from the following sizing agent types: acidic sizing agents, basic sizing agents, neutral sizing agents or a mixture of any of these and can be e.g., alkyl ketene dimer (AKD), alkyl succinic anhydride (ASA) or rosin, waxes, or derivatives or combination thereof.

The web may further comprise plasticizing agents such as sugar alcohol or other water-soluble polymers such as PVOH, that improves film formation, convertability and recycling. Particularly, the web may comprise plasticizing agents that have low molecular weight and are highly hydrolyzed. Preferably, the web comprises plasticizing agents in an amount in a range of between 0-30 wt %, such as 1-30 wt %. By use of the present invention, the web may comprise such plastizing agents although that makes it sensitive to water.

As mentioned, the method of the first aspect of the invention includes the step of applying at least one first composition on the first side of the web while the second side of the web is in contact with the heated roll or belt. With “in contact” is meant that the second side of the web is in direct contact with the heated roll or belt. In embodiments, the web is in contact with the heated roll or bed also before being applied with the first composition. The web may be in contact with the heated roll or belt for a period of 0.001-5 seconds, or 0.1-5 seconds, or 0.1-3 seconds, or 1-3 seconds before being provided with the first composition. In this way, the web is pre-heated heated from beneath, which further enhances the immediate evaporation of the water applied with the aqueous composition on the web.

In embodiments, the said heated roll or belt is induction heated. The use of induction heating enables a faster and more even heating of the web, enabling fast evaporation of the water applied with the composition whereby less water is penetrating the web causing the said problems.

The step of applying the first composition on the web while this is in contact with the heated roll or belt can be applicable in an on-line or an off-line method (on-line or off-line with the method of producing the barrier substrate). In embodiments it can be made in a converting line, e.g. on a printing machine.

The barrier coated web is preferably dried immediately after the application of the first composition. In embodiments, the web drying can be enhanced by installing at least one dryer, such as an infrared (IR) or air dryer, located immediately after the application point while the web is still in contact with the heated roll or belt, and optionally an additional dryer closely after the web is released from the roll or belt.

In embodiments, the method further comprises a step of measuring a quality characteristic of the barrier coated web, which quality characteristic is used to regulate the induction heating of the roll or belt. The quality characteristic may be one or several characteristics chosen from the group of roughness, permeability, porosity, smoothness, gloss, ash content and moisture content. This may be accomplished by arranging a sensor downstream from the first coating step measuring at least one of said characteristics, which measurement is used to control the induction heating of the roll or belt.

The temperature of the roll or belt is preferably between 50-250° C., more preferably between 80-120° C. With the temperature of the roll or belt is meant the surface temperature, i.e. the temperature of the roll or belt that is in contact with the web while being applied with the first composition. The temperature of the web before being contacted with the induction heated roll or belt may be at least 25° C. or at least 35° C., or preferably at least 45° C., such as between 25-80° C. or 35-80° C. or 45-80° C. The temperature of the web is preferably above 80° C., such as between 90-100° C. at the time it is applied with the first composition.

In embodiments, the composition applied on the first side of the web in the first coating step comprises a polymer dispersed or dissolved in an aqueous medium in an amount of at least 40 wt %, or at least 60 wt %, such as between 50-100 wt % or 50-99 wt % or 60-100 wt % as calculated on the total solid content of the first composition.

In embodiment, the polymer of the first composition is selected from the group consisting of a polyvinyl alcohol, a modified polyvinyl alcohol, a polysaccharide or a modified polysaccharide, a polyester or combinations thereof. The polysaccharide may be, for example, starch, hemicellulose or xylan, microfibrillated cellulose (MFC), nanocrystalline cellulose or combinations thereof. The modified polysaccharide may be, for example, a modified cellulose, such as carboxymethylcellulose (CMC), hydroxypropyl cellulose (HPC), hydroxyethyl cellulose (HEC), ethylhydroxyethyl cellulose (EHEC) or methyl cellulose, or a modified starch, such as hydroxypropylated starch or dextrin. The polyester may e.g. be polyhydroxyalkanoate (PHA).

In embodiments, the first composition comprises a latex emulsion, preferably a styrene-butadiene (SB) latex or a styrene-acrylate (SA) latex or combinations thereof.

The invention enables the application of aqueous-based compositions with high water retention values and/or at low solid contents, which improves the coating runability and improves the film forming

Said first composition may have a solid content of between 0.1-50 wt %, or 1-50 wt % or 1-30 wt. %, preferably 1-20 wt %, more preferably between 2-15 wt %. In some embodiment the first composition has a solid content of 20-50 wt %, or 25-50 wt %.

In some embodiments, said first composition has a water retention value of above 40 g/m2, more preferably above 50 g/m², or above 60 g/m² as measured in accordance with TAPPI T 701 pm-01 standard.

The first barrier layer has preferably a coat weight of 0.1-12 gsm, preferably 0.5-8 gsm, or 0.5-6 gsm, or 2-6 gsm or 4-6 gsm, calculated as dry weight.

The method of the invention may further comprise a step of applying at least one second composition comprising a polymer dispersed or dissolved in an aqueous medium on the first side of the web, in at least one second coating step, thereby providing the web with at least one second barrier layer. Preferably, the second barrier layer is formed on the first barrier layer. The polymer of the at least one second composition may be selected from the same group of polymers as the polymer of the first aqueous-based solution or dispersion. The at least one second composition may further be a latex. The at least one second composition may be applied on the web while this is contact with a heated, preferably induction heated, roll or belt. Alternatively, said at least one second coating step may be a conventional coating step, not including a heated roll or belt. The method may further comprise adding further aqueous-based barrier layers on the web. In these embodiments, the total coat weight of the first and second barrier layer may be between 2-12 gsm, preferably between 4-8 gsm, calculated as dry weight.

The first barrier layer and the optional second barrier layer may be applied by contact or non-contact coating methods. Examples of useful coating methods include, but are not limited to, rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating

According to a second aspect illustrated herein, there is provided a barrier substrate obtainable by the method according to the first aspect.

In some embodiments, the barrier substrate has an oxygen transfer rate (OTR), measured according to the standard ASTM D-3985 at 50% relative humidity and 23° C., of less than 100 cc/m²/day, preferably less than 80 cc/m²/day, more preferably less than 50 cc/m²/day, most preferably less than 40 cc/m²/day, even more preferably less than 20 cc/m²/day.

In some embodiments, the barrier substrate has an oxygen transfer rate (OTR), measured according to standard ASTM D-3985 at 80% relative humidity and 23° C. of less than 200 cc/m²/day, preferably less than 150 cc/m²/day, more preferably less than 100 cc/m²/day, most preferably less than 80 cc/m²/day, even more preferably less than 50 cc/m²/day. In some embodiments, the obtained barrier substrate has a water vapor transmission rate (WVTR) value vapor transfer rate (WVTR), measured according to the standard ASTM F1249 at 50% relative humidity and 23° C., of less than 50 g/m²/day, preferably less than 35 g/m²/day, more preferably less than 20 g/m²/day, most preferably less than 15 g/m²/day, even more preferably less than 10 g/m²/day.

According to a third aspect illustrated herein, there is provided a method of producing a barrier substrate laminate, e.g. for a paper or paper-based packaging material, comprising the barrier substrate obtainable by the method according to the first aspect, wherein the method comprises the steps of.
performing the method according to the first aspect so as to form said barrier substrate, and
laminating the barrier substrate with at least one additional polymer layer or extruding at least one additional polymer layer to said barrier substrate so as to form said barrier substrate laminate.

For example, the one or more additional polymer layers may be constituted by any suitable polyolefin, such as polyethylene, high-density polyethylene (HD-PE), low-density polyethylene (LD-PE), polypropylene, low-density polypropylene (LD-PP), biaxially-oriented polypropylene (BO-PP), polyethylene terephthalate (PET), etc. or mixtures or modifications thereof that could readily be selected by a skilled person. The one or more additional polymer layer(s) may also be constituted by bio-derived or recyclable and/or compostable versions, such as polylactic acid (PLA), polyglycolic acid (PGA), polyhydroxyalkanoates (PHA), etc. The additional polymer layer(s) may comprise any of the thermoplastic polymers commonly used in paper or paperboard based packaging materials in general or polymers used in liquid packaging board in particular. Polyethylenes, especially low-density polyethylene (LDPE) and high-density polyethylene (HDPE), are the most common and versatile polymers used in liquid packaging board.

According to a fourth aspect illustrated herein, there is provided a barrier substrate laminate obtainable by the method according to the third aspect.

According to a fifth aspect illustrated herein, there is provided a paper or paperboard-based packaging material comprising the barrier substrate according to the second aspect or the barrier substrate laminate according to the third aspect, laminated with a paper or paperboard base material.

### DESCRIPTION OF EMBODIMENTS

In the following, the invention will be further illustrated by description of three exemplified embodiments with reference to the accompanying drawings, wherein:

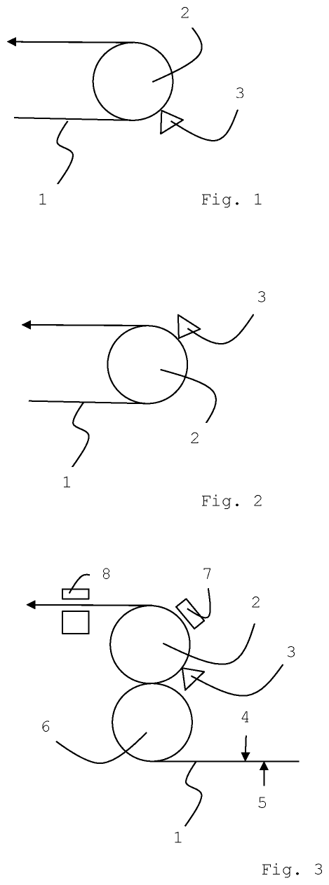

FIG. 1 shows a schematic overview of the process according to a first embodiment.

FIG. 2. shows a schematic overview of the process according to a second embodiment.

FIG. 3. shows a schematic overview of the process according to a third embodiment.

In the embodiment illustrated in FIG. 1, a web (1) comprising a high amount of highly refined fibers or MFC is conducted to a backing roll (2), which backing roll (2) is induction heated. While the web (1) is in contact with the backing roll (2), an aqueous barrier composition is applied onto the web (1) by means of a coating head (3).

The embodiment illustrated in FIG. 2 differs from the embodiment shown in FIG. 1 in that the web (1) is in contact with the backing roll (2) for a longer period of time prior to the application of the aqueous barrier composition.

In the embodiment illustrated in FIG. 3, the web (1), comprising a first side (4) and a second side (5), is first conducted to a second induction heated backing roll (6) such that the first side (4) of the web is in contact with the second backing roll (6). Thereafter, the web (4) is conducted to a first backing roll (2) such that the second side (5) of the web is in contact with the first backing roll (2). In this embodiment, the aqueous barrier composition is applied to the first side (4) of the web, while this is in contact with the first backing roll (2). The barrier coated web (1) is dried by means of a first dryer (7) while the web is in contact with the first backing roll (2). The web is further dried by means of a second dryer (8) arranged closely after the web is released from the backing roll (2).

While certain representative embodiments and details have been shown for purposes of illustrating the invention, it will be apparent to those skilled in the art that various changes in the invention disclosed herein may be made without departing from the scope of the invention, which is defined in the appended claim

1. A method for manufacturing a barrier substrate, comprising the steps of:
providing a web comprising at least one first layer, wherein the at least one first layer comprises at least 30 weight-% highly refined cellulose fibers having a Schopper Riegler value of 60-95 SR°, or at least 30 weight-% microfibrillated cellulose (MFC), as calculated on a total dry weight of said at least one first layer, or both, and wherein the web has a first side and a second side, and exhibits an air resistance (Gurley) of at least 1000 s/100 ml as measured according to ISO 5636-5,
providing a heated roll or a heated belt, and,
applying, in a first coating step, at least one first composition comprising a polymer dispersed or dissolved in an aqueous medium on the first side of the web while the second side of the web is in contact with the heated roll or belt so that water applied with the aqueous medium on the web is evaporated, thereby providing the web with a first barrier layer forming a barrier coated web, and,
optionally drying said web provided with the first barrier layer in a drying step.

2. The method according to claim 1, wherein the web has a grammage of less than 65 gsm.

3. The method according to claim 1, wherein the web has a density of above 600 kg/m³.

4. The method according to claim 1, wherein the web, before being applied with the at least one first composition, exhibits a water absorption value of above 15 g/m², as measured on the first side using COBB₆₀ in accordance with ISO 535:2014.

5. The method according to claim 1, wherein the web has a wet strength of below 0.7 kN/m, as measured according to ISO 3781.

6. The method according to claim 1, wherein the at least one first layer comprises internal sizing agents in an amount of less than 2 kg/ton, as calculated on the dry weight of said at least one first layer.

7. The method according to claim 1, wherein said heated roll or said heated belt is induction heated.

8. The method according to claim 7, further comprising a step of:
measuring a quality characteristic of the barrier coated web, said quality characteristic used to regulate the induction heating of the roll or belt.

9. The method according to claim 1, wherein the temperature of the heated roll or the heated belt is between 50-250° C.

10. The method according to claim 1, wherein the polymer of the first composition dispersed or dissolved in the aqueous medium is selected from a group consisting of: a polyvinyl alcohol, a modified polyvinyl alcohol, a polyester, a polysaccharide or a modified polysaccharide, and combinations thereof.

11. The method according to claim 1, wherein the first composition comprises a latex emulsion.

12. The method according to claim 1, wherein said first composition has a solid content of between 1-20 wt %.

13. The method according to claim 1, wherein said first composition has a water retention value of above 40 g/m², as measured in accordance with TAPPI T 701 pm-01 standard.

14. The method according to claim 1, wherein the first barrier layer has a coat weight of 0.1-12 gsm, calculated as dry weight.

15. The method according to claim 1, further comprising:
applying at least one second composition comprising a polymer dispersed or dissolved in an aqueous medium on the first side of the web, in at least one second coating step, thereby providing the web with at least one second barrier layer.

16. The method according to claim 15, wherein a total coat weight of the first barrier layer and the at least one second barrier layer is between 2-12 gsm, calculated as dry weight.

17. A barrier substrate obtained by to the method according to claim 1.

18. A method of manufacturing a barrier substrate laminate comprising the steps of:
performing the method according to claim 1 so as to form said barrier substrate, and
laminating said barrier substrate with at least one additional polymer layer or extruding at least one additional polymer layer to said barrier substrate so as to form said barrier substrate laminate.

19. A barrier substrate laminate obtained by the method according to claim 18.

20. A paper or paperboard-based packaging material comprising:
the barrier substrate according to claim 17.
